(19) United States
(12) Patent Application Publication
(10) Pub. No.: US 2025/0086484 A1
(43) Pub. Date: Mar. 13, 2025

(54) HYBRID FIELD-AWARE FACTORIZATION MACHINES MODEL

(71) Applicant: Taboola.com Ltd, Ramat Gan (IL)

(72) Inventors: Alexander Gorohovski, Beer Sheva (IL); Maoz Cohen, Lehavim (IL)

(21) Appl. No.: 18/243,496

(22) Filed: Sep. 7, 2023

(51) Int. Cl. G06N 5/046

(52) U.S. Cl. CPC G06N 5/046

(57) ABSTRACT

A system, a computerized apparatus and a method comprising obtaining a hybrid Field-aware Factorization Machines (FFM) model that is based on a set of fields comprising at least a first field and a second field. The hybrid FFM model comprises a single embedding vector representing the first field, and a plurality of embedding vectors representing the second field, each of which corresponds to a different field of the set of fields in addition to the second field. The method further comprises performing, by a computerized device, inference using the hybrid FFM model with respect to an instance, whereby obtaining a label, by extracting based on the instance a first value for the single embedding vector of the first field and a plurality of values corresponding the plurality of embedding vectors representing the second field; and automatically performing a responsive action based on the label of the instance.

### TECHNICAL FIELD

The present disclosure relates to factorization machines models in recommender systems, in general, and to hybrid field-aware factorization machines models, in particular.

### BACKGROUND

Taboola™ is a content discovery platform that provides personalized recommendations for online users. Taboola™ runs a large-scale online recommender system to provide personalized content recommendations. The system is primarily used by publishers and advertisers such as an “open web” online advertising tool to promote their content and increase engagement on their websites.

The system analyzes user behavior and interests to deliver relevant content recommendations in the form of sponsored links, widgets, and native ads. In order to provide personalized recommendations and increase user engagement, the system utilizes machine learning based models to estimate the probability of a user to click on a certain item.

Click-through rate (CTR) is a metric used in digital marketing to measure the effectiveness of an advertising campaign or the engagement of a specific link. CTR of an item represents the percentage of people who clicks on a particular link or advertisement out of the total number of impressions it receives. Click-through rate (CTR) prediction plays a critical role in recommender systems and online advertising. A higher CTR generally indicates that the advertisement or link is compelling and relevant to the audience, as it suggests a higher level of engagement. It is often used as a performance indicator to assess the effectiveness of digital advertising campaigns and optimize them for better results. A low CTR may indicate that the ad is not resonating with the target audience or that it needs to be optimized to improve its click-worthiness.

### BRIEF SUMMARY

One exemplary embodiment of the disclosed subject matter is a method comprising: obtaining a hybrid Field-aware Factorization Machines (FFM) model, wherein the hybrid FFM model is based on a set of fields, the set of fields comprise at least a first field and a second field, the hybrid FFM model comprises a single embedding vector representing the first field, the hybrid FFM model comprises a plurality of embedding vectors representing the second field, wherein each embedding vector of the plurality of embedding vectors corresponds to a different field of the set of fields in addition to the second field: performing, by a computerized device, inference using the hybrid FFM model with respect to an instance, whereby obtaining a label, wherein said performing inference comprises extracting based on the instance a first value for the single embedding vector of the first field and a plurality of values corresponding the plurality of embedding vectors representing the second field; and automatically performing a responsive action based on the label of the instance.

Optionally, the set of fields consists of exactly N fields, wherein the plurality of embedding vectors consists of exactly N−1 embedding vectors, each of which corresponding to a different field other than the second field.

Optionally, the method further comprises after said automatically performing the responsive action, re-training the hybrid FFM model, wherein said re-training comprises: determining, for each field of the set of fields, whether the field is represented by a single embedding vector or by a plurality of field-aware embedding vectors; and computing values for embedding vectors for all fields of the set of fields.

Optionally, said determining for each field of the set of fields whether the field is represented by a single embedding vector or by a plurality of field-aware embedding vectors comprises at least one of: determining that the first field is to be represented by a plurality of field-aware embedding vectors; and determining that the second field is to be represented by a single embedding vector; whereby said re-training modifies a number of embedding vectors used to represent a field in the hybrid FFM model compared to their respective number in the hybrid FFM model before said re-training.

Optionally, the hybrid FFM model comprises no more than 40% fields that are represented by a single embedding vector.

Optionally, the hybrid FFM model comprises: at least 10% of the fields that are represented by a single embedding vector; and at least 10% of the fields that are represented by a plurality of field-aware embedding vectors.

Another exemplary embodiment of the disclosed subject matter is a method for training a hybrid FFM model, the method comprises: obtaining a set of fields, the set of fields comprises at least a first field and a second field, the set of fields consists of N fields; training a FFM model, wherein the FFM model is based on the set of fields, the FFM model comprises for each field of the set of fields N−1 embedding vectors representing the field, each of which corresponds to a different field of the set of fields, whereby the FFM model, comprises N2−N embedding vectors; based on the FFM model, determining for each field of the set of fields, whether the field is to be represented in the hybrid FFM model by a single embedding vector or by a set of N−1 field-aware embedding vectors, whereby determining that the first field is to be represented by a single embedding vector and determining that the second field is to be represented by N−1 field aware embedding vectors; computing values for embedding vectors of the hybrid FFM model, whereby the hybrid FFM model comprises no more than N2−2N+2 embedding vectors, whereby the hybrid FFM model is smaller than the FFM model.

Optionally, said determining for each field of the set of fields, whether the field is to be represented in the hybrid FFM model by a single embedding vector or by a set of N−1 field-aware embedding vectors comprises: computing for each embedding vector of the FFM model an importance measurement; for each field of the set of fields: identifying a second highest importance measurement of an embedding vector representing the field, and determining the field to be represented by a single embedding vector if and only if the second highest importance measurement of the embedding vector representing the field is below a threshold.

Optionally, the importance measurement of each embedding vector is computed based on Shapely Additive Explanations (ShAP) technique.

Yet another exemplary embodiment of the disclosed subject matter is a computerized apparatus comprising: one or more memory units and one or more processors; said one or more memory units being adapted to retain: a FFM model, wherein the FFM model is based on a set of fields consisting of N fields, the FFM model comprises for each field of the set of fields N−1 embedding vectors representing the field, each of which corresponds to a different field of the set of fields, whereby the FFM model, comprises N2−N embedding vectors; a hybrid FFM model, wherein the hybrid FFM is based on the set of fields, wherein at least a first field of the set of fields is represented in the hybrid FFM model with a single embedding vector and at least a second field of the set of fields is represented in the hybrid FFM model with N−1 embedding vectors, wherein each embedding vector of the N−1 embedding vectors corresponds to a different field of the set of fields in addition to the second field; and at least one of said one or more processors being adapted to periodically train the FFM model, wherein the FFM model is based on the set of fields, wherein said periodically training the FFM model is performed at intervals of a first time-duration; at least one of said one or more processors being adapted to select the first field to be represented in the hybrid FFM model with a single embedding vector and to select the second field to be represented in the hybrid FFM model with N−1 embedding vectors, wherein the selection of the first and second fields is based on the FFM model; at least one of said one or more processors being adapted to periodically train the hybrid FFM model, wherein said periodically training the hybrid FFM model is performed at intervals of a second time-duration, the second time-duration is smaller than the first time-duration; at least one of said one or more processors being adapted to utilize the hybrid FFM model for inference with respect to an instance, whereby obtaining an inference result, wherein the inference result is based on a first value with respect to the instance for the single embedding vector of the first field and based on a plurality of values with respect to the instance corresponding the plurality of embedding vectors representing the second field; and at least one of said one or more processors being adapted to perform a responsive action based on the inference result.

Optionally, the first time-duration includes at least ten consecutive second time-durations.

Optionally, the hybrid FFM model comprises no more than N2−2N+2 embedding vectors, whereby the hybrid FFM model is smaller than the FFM model.

Optionally, at least 50% of the N fields are selected to be represented by a single embedding vector.

Optionally, at least 60% of the N fields are selected to be represented by a single embedding vector.

Optionally, the selection with respect to a field is performed by: computing an importance measurement for each embedding vector of the FFM model that is associated with the field; identifying a second highest importance measurement of an embedding vector representing the field; in response to the second highest importance measurement being below a threshold, determining that the field is to be represented by a single embedding vector; and in response to the second highest importance measurement being above the threshold, determining that the field is to be represented by a plurality of embedding vectors.

Optionally, the single embedding vector is the embedding vector representing the field in the FFM model with a highest importance measurement.

Optionally, the first time-duration is about a month, wherein the second time-duration is about a day.

Yet another exemplary embodiment of the disclosed subject matter is a system for hybrid FFM model generation and update, comprising: an FFM model, wherein the FFM model is based on a set of fields consisting of N fields, the FFM model comprises for each field of the set of fields N−1 embedding vectors representing such field, each of which corresponds to a different field of the set of fields, whereby the FFM model, comprises N2−N embedding vectors; a training module configured to train the FFM model periodically at intervals of a first time-duration; an identification module configured to identify, based on the FFM model, field aware features to be represented by multiple embedding vectors in the hybrid FFM and features to be represented by a single embedding vector in the hybrid FFM; a generation module configured to generate the hybrid FFM model based on the set of fields, wherein the hybrid FFM model comprises the determined representation for each field, wherein at least one field in the hybrid FFM is represented by a single embedding vector and at least one field in the hybrid FFM is represented by the N−1 embedding vectors representing the field in the FFM model; an update module configured to periodically train the hybrid FFM model once every frequent time period.

Optionally, the system further comprises: an importance computation module configured to compute an importance measurement for each embedding vector of the FFM model; wherein said identification module is configured to determine, for each field of the set of fields, whether the field is to be represented in the hybrid FFM model by a single embedding vector or by a set of N−1 field-aware embedding vectors, wherein the determination is based on the second highest importance measurement of the embedding vector representing each field being below a threshold.

### THE BRIEF DESCRIPTION OF THE SEVERAL VIEWS OF THE DRAWINGS

The present disclosed subject matter will be understood and appreciated more fully from the following detailed description taken in conjunction with the drawings in which corresponding or like numerals or characters indicate corresponding or like components. Unless indicated otherwise, the drawings provide exemplary embodiments or aspects of the disclosure and do not limit the scope of the disclosure. In the drawings:

FIG. 1 shows a flowchart diagram of a method, in accordance with some exemplary embodiments of the disclosed subject matter;

FIG. 2 shows a flowchart diagram of a method, in accordance with some exemplary embodiments of the disclosed subject matter;

FIG. 3 shows a schematic illustration of exemplary models, in accordance with some exemplary embodiments of the disclosed subject matter; and

FIG. 4 shows a block diagram of an apparatus, in accordance with some exemplary embodiments of the disclosed subject matter.

### DETAILED DESCRIPTION

A commonly used model in recommender systems, in general, and for CTR prediction is Factorization Machines (FM). FM models may be a type of machine learning models that excel at capturing feature interactions in recommendation tasks. FM models combine linear and factorized terms to capture interactions between features. By leveraging matrix factorization techniques, FM models may create latent factors that represent the underlying relationships between features. The latent factors may enable FM models to capture higher-order interactions and non-linear relationships, making them suitable for recommender systems.

In some exemplary embodiments, FM models may be applied in recommender systems for CTR prediction. Given a user-item pair or a set of features, the FM model may be utilized to calculate the predicted CTR by combining the linear terms and factorized interactions. As an example, the interaction of pairs of features may be modeled by dot products of two feature embedding vectors. The FM model may be configured to learn an embedding (dense vectorial representation) for each feature, performs a dot product operation on each pair of embeddings, and finally feeds it into a fully connected part of the network. The FM model may be configured to model the interaction between two features as the dot product of their corresponding embedding vectors. The predicted CTR may be used to rank and recommend items to users based on their likelihood of interaction. FM models may be suitable in recommender systems due to their ability to handle high-dimensional and sparse data, effectively capture feature interactions, and provide personalized recommendations.

Additionally, or alternatively, a FFM model may be utilized to consider the field information to model the different interaction effects of features from different field pairs. FFM may be configured to model the difference explicitly by learning n−1 embedding vectors for each feature (where n is the number of fields), and uses only the representing embedding based on the field it interacts with (a unique embedding per each of the features). FFM may be an extension of FM models, that incorporate the concept of feature fields. FFM models aim to capture interactions not only between features but also within specific groups or fields of related features. In FFM, each feature may be associated with a specific field, indicating the domain or context to which it belongs. As an example, in a recommendation system, fields could include user demographics, item categories, contextual information, or the like. FFM may be configured to different feature pairs having different levels of relevance and interactions depending on the fields they belong to. By introducing field information, FFM may capture the complex relationships and interactions within each field, leading to improved prediction accuracy.

One technical problem dealt with by the disclosed subject matter is selection of models to utilize in recommender systems, particularly for CTR prediction. When employing FM and FFM for CTR prediction or other predictions in recommender systems, various technical challenges may arise. Determining which model to use may not always be straightforward or simple. FFM modeling may generally be more expressive than FM modeling, allowing for modeling of more complex interactions due to the larger number of parameters. Consequently, FFM often achieves significant performance improvements over FM. However, FFM modeling may present drawbacks in real-world production systems, as it can significantly increase training and serving times, memory requirements, and the like. Furthermore, FFM models may have a tendency to overfit, which is a critical concern in machine learning.

One technical solution is to generate and employ a hybrid FFM model to be utilized for performing inferences with respect to instances based on values corresponding to the embedding vectors. The inference process may result in obtaining a label for the instance, such as but not limited to a predicted CTR which can be used to automatically perform a responsive action. The approach is based on the assumption that not all fields benefit from having multiple embeddings. The hybrid FFM model may be based on a set of fields, in which some fields mat be represented using a single embedding vector (such as in FM models), while other fields may be represented with a plurality of embedding vectors (n−1 or less, but more than one, such as in FFM models). Each embedding vector in the plurality corresponds to a different field from the set of fields, in addition to the field being represented thereby.

In some exemplary embodiments, the hybrid FFM model may be generated based on a respective FFM model. Each field of the set of fields, may be analyzed to determine whether to be represented by a single embedding vector or by a plurality of field-aware embedding vectors. The determination may be performed based on importance measurements of the embedding vectors, such as ShAP measurements. In some exemplary embodiments, a field is determined to be represented by a single embedding vector if and only if the second highest importance measurement of the embedding vector representing the field is below a threshold. The threshold may be a numerical value determined empirically, such as about 0.01, about 0.045, about 0.7, or the like. If a feature's second-highest ShAP value or other importance measurements of the second most valuable embedding), is below the threshold, it may indicate none of the additional features (other than the first one) provide significant information. This may suggest that the feature does not benefit from having multiple embeddings. Such features may be modified to have only one embedding vector, akin to FM modeling.

It may be noted that representing a field with a single embedding vector may simplify the model and reduce its complexity by eliminating embeddings. If the second highest importance is low, it suggests that the interactions captured by the additional embeddings for the field are not significant or do not provide substantial improvement. Therefore, using a single embedding vector for the field is a practical choice to maintain model efficiency without sacrificing performance in a significant manner.

The generation or re-generation of the hybrid FFM model based on the FFM model, may be performed periodically at intervals of large time-durations, such as once a month, once every 40 days, or the like. The re-generation (also referred to as re-training process) may include determining, for each field of the set, whether the field should be represented by a single embedding vector or a plurality of field-aware embedding vectors. Subsequently, values for the embedding vectors are computed for all fields in the set. The re-generation modifies a number of embedding vectors used to represent a field in the hybrid FFM model compared to their respective number in the hybrid FFM model before said re-generation or re-training. While the FFM model includes N−1 embedding vectors representing each field (i.e., N²−N embedding vectors in total), the hybrid FFM model may include less than N²−N embedding vectors and specifically no more than N²−2N+2 embedding vectors. To ensure efficiency, the hybrid FFM model may comprise no more than about 20%, about 30%, about 33%, about 40%, about 50% or the like of fields that are represented by a single embedding vector (e.g., switched from being field-aware (with multiple embeddings) to being not-field-aware (with a single embedding)). However, other distribution may be set based on the requirements of the model, such as the performance of the model, the required accuracy, or the like. As an example, the hybrid FFM model may be designed to include at least about 10% of fields represented by a single embedding vector and at least about 10% of fields represented by a plurality of field-aware embedding vectors.

In some exemplary embodiments, the hybrid FFM model may be trained periodically based on the hybrid representation of the set of fields, such as after a predetermined time period, at intervals of small time-duration, such as daily, or every few hours, or the like.

One technical effect of utilizing the disclosed subject matter is to improve performance of recommender systems, particularly in CTR prediction. By utilizing a hybrid FFM model that combines the strengths of both FM and FFM, the solution aims to achieve improved performance in predictions in recommender systems. The hybrid model takes advantage of the expressiveness of FFM in modeling complex feature interactions while mitigating the potential drawbacks associated with FFM, such as increased training and serving times and overfitting. By striking a balance between FM and FFM, the solution can enhance prediction accuracy and deliver more effective CTR predictions.

Another technical effect of utilizing the disclosed subject matter is reducing computational and storage complexity and improving resource utilization. The hybrid FFM model addresses the resource-intensive nature of FFM by selectively choosing which fields benefit from having multiple embedding vectors and which fields can be adequately represented by a single embedding vector, similar to FM models. By determining the appropriate representation for each field based on importance measurements, such as ShAP, the solution may optimize memory requirements and computational efficiency. This allows for more efficient training and serving of the recommender system, reducing the overall resource footprint. Furthermore, the hybrid FFM model is expressive comparing to FM models due to its larger number of parameters, thereby leading to improved performance by modeling more complex interactions. On the other hand, the complexity and resource requirements of the hybrid

FFM model are decreased comparing to FFM models providing similar expressivity.

Yet another technical effect of utilizing the disclosed subject matter is providing periodic model adaptation. The solution incorporates a periodic re-generation or re-training process for the hybrid FFM model. By periodically analyzing the importance measurements of embedding vectors and determining the optimal representation for each field, the model can adapt to changing data patterns and feature relevance. The periodicity of the re-generation process, which can be set based on specific time intervals (e.g., monthly or every few weeks), ensures that the model remains up to date and aligned with the evolving dynamics of the recommender system. As the training of the FFM models upon which the hybrid FFM model is generated, is performed less often, memory and computational resources for training and serving, which can be a challenge in FFM models, may be reduced. In addition, less often hyperparameter tuning is required. FFM models have hyperparameters that need to be tuned to achieve optimal performance. Tuning these hyperparameters can be time-consuming and require significant computational resources, especially when dealing with large datasets or complex feature-field structures.

Yet another technical effect of utilizing the disclosed subject matter is enabling flexibility in field representation. The solution provides flexibility in deciding the distribution of fields represented by a single embedding vector and those represented by a plurality of field-aware embedding vectors in the hybrid FFM model. The specific distribution can be tailored based on the requirements of the model, performance considerations, desired accuracy, or other relevant factors. This flexibility allows for customization and fine-tuning of the hybrid model to achieve the desired balance between efficiency and accuracy, depending on the specific recommender system and its objectives.

Yet another technical effect of utilizing the disclosed subject matter is to increase scalability. By considering the number of embedding vectors used to represent each field, the solution ensures scalability of the hybrid FFM model. Compared to the FFM model, which requires N−1 embedding vectors per field (resulting in N²−N embedding vectors in total), the hybrid FFM model limits the number of embedding vectors to no more than N²−2N+2. This constraint enables the model to scale more efficiently, particularly when dealing with a large number of fields or features, without sacrificing its effectiveness in capturing interactions within and between fields. In addition to reducing the required memory for store the additional parameters associated with feature-field pairs, this improvement can overcome challenges in memory-constrained environments, particularly when dealing with large-scale recommender systems and handling a large number of features and fields.

Yet another technical effect of utilizing the disclosed subject matter is to limit overfitting of the prediction models. While FFM models tend to have a higher risk of overfitting, when the model fitting too closely to the training data and performing poorly on unseen data. Overfitting can lead to decreased generalization performance and reduced accuracy in CTR prediction. The reduced number of embedding vectors in hybrid FFM models compared to FFM models, enables mitigating overfitting, especially when the training data is limited. For similar reasons, the hybrid FFM model improves model serving and inference time. In production systems, where low-latency responses are crucial, the longer serving time can be a significant drawback. The reduced number of parameters, embedding vectors and computations in hybrid FFM models reduced inference or serving time for making real-time predictions.

The disclosed subject matter may provide for one or more technical improvements over any pre-existing technique and any technique that has previously become routine or conventional in the art. Additional technical problem, solution and effects may be apparent to a person of ordinary skill in the art in view of the present disclosure.

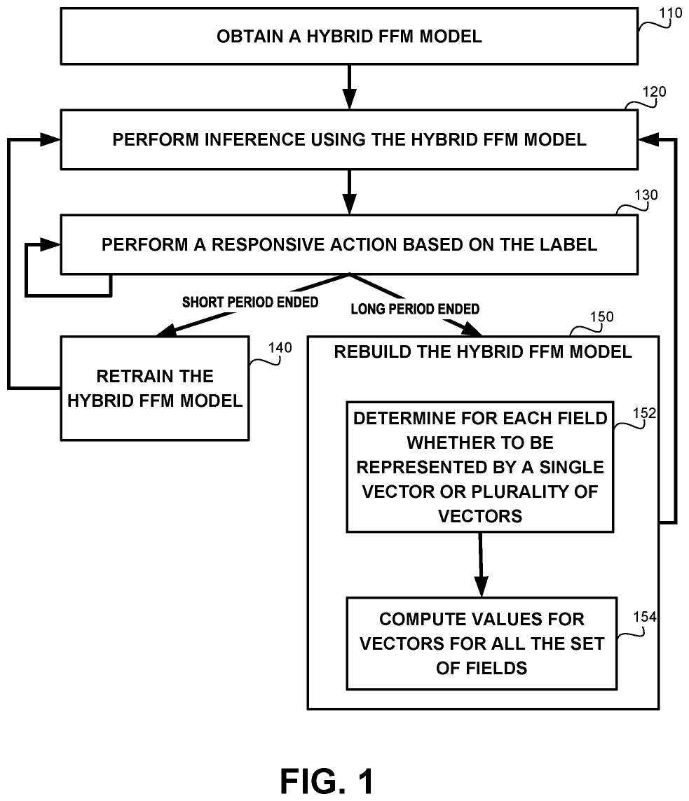

Referring now to FIG. 1 showing a flowchart diagram of a method, in accordance with some exemplary embodiments of the disclosed subject matter.

On Step 110, a hybrid FFM model may be obtained. In some exemplary embodiments, the hybrid FFM model may be based on a set of fields comprising N fields The hybrid FFM model may be configured to incorporate both single embedding vectors and a plurality of embedding vectors for different fields. Specifically, the set of fields comprises at least a first field and a second field, and the hybrid FFM model includes a single embedding vector representing the first field, and a plurality of embedding vectors (N−1 in total) representing the second field. Each of these N−1 embedding vectors corresponds to a different field in addition to the second field. The hybrid FFM model may be designed to optimize the representation of fields, striking a balance between computational efficiency and accurate modeling of feature interactions.

In some exemplary embodiments, the hybrid FFM model may be a modified version of an existing FFM model that combines single embedding vectors and field-aware embedding vectors for different fields. The hybrid FFM optimizes the representation of fields of the existing FFM model based on importance measurements thereof.

In some exemplary embodiments, the hybrid FFM model may comprise about 30% of the fields represented by a single embedding vector. The representation of fields in the hybrid FFM model may be selected in manner aiming to strike a balance between computational efficiency and accurate modeling of feature interactions. To achieve computational efficiency, the hybrid FFM model limits the number of fields represented by a single embedding vector. Specifically, the model comprises no more than 40% of fields that are represented by a single embedding vector. By reducing the number of embedding vectors for a portion of the fields, the model conserves memory and computational resources, but still provide accurate modeling of feature interactions. Additionally, or alternatively, the hybrid FFM model ensures that a significant portion of the fields are represented by a plurality of field-aware embedding vectors. Specifically, the model may include at least 10% of the fields that are represented by a single embedding vector and at least 60% of the fields that are represented by a plurality of field-aware embedding vectors. This ensures that the model can capture the complex relationships and interactions within and between the fields. By maintaining such balance, the hybrid FFM model optimizes the representation of fields. It conserves computational resources by limiting the number of fields represented by a single embedding vector, while still accurately modeling feature interactions by utilizing a substantial portion of fields with multiple field-aware embedding vectors. This balanced representation enhances the efficiency and accuracy of the hybrid FFM model in generating recommendations in recommender systems.

On Step 120, the hybrid FFM model may be utilized to perform inference with respect to an instance, e.g., obtaining a label for the instance. The inference may be related to recommender systems, to CTR computation, or the like.

In some exemplary embodiments, performing, the inference may be performed by a computerized device applying the hybrid FFM model. The hybrid model utilizes its learned parameters and feature interactions to estimate the probability or likelihood of the label based on a set of features associated with the instance. The inference may comprise extracting based on the instance a first value for the single embedding vector of the first field and a plurality of values corresponding the plurality of embedding vectors representing the second field. The label may be determined based on the first value and the plurality of values. As an example, the label may represent whether or not a user clicked on a particular item or advertisement. In this example, the label may be a binary value, with 1 indicating a click (positive label) and 0 indicating no click (negative label). However, other types of labels may be determined, such continuous value indicating a predicted CTR representing the model's estimation of the likelihood of the user clicking on the given item or advertisement based on the input features. As an example, the input instance may be associated with user demographics, item characteristics, and contextual information. The hybrid FFM model utilizes the embeddings and feature interactions to estimate the CTR or the probability of the user clicking on the presented item.

On Step 130, a responsive action may be automatically performed based on the label of the instance. The responsive action may be performed by the device performing the inference, by the system providing the hybrid FFM model, or by another entity, such as related the recommender systems, CTR computation entity, or the like.

In some exemplary embodiments, the responsive action may be providing content recommendation to the user based on the predicted label, such as providing as a list of articles, videos, products, or any other relevant items that the user is likely to engage with based on their interests and preferences. Additionally, or alternatively, the responsive action may be related to ad placement, such as when the instance pertains to an advertising scenario, the system can automatically determine the optimal placement and display of advertisements for the user. As an example, the predicted CTR may be used to identify the most suitable ad content and placement strategy, ensuring that ads with higher probabilities of engagement are shown in prominent positions to maximize click-through rates. Additionally, or alternatively, the responsive action may be based on personalized ranking that is determined based on the label, such as ranking items or recommendations tailored to the user's preferences. By sorting the available content or products based on their likelihood of user interaction, the system can present a personalized ranking that prioritizes the most relevant and engaging options for the user. Additionally, or alternatively, the responsive action may be dynamically adjusting a user interface based on the predicted label. This can involve modifying the layout, content placement, or design elements to emphasize items that are expected to have higher engagement rates. By customizing the interface to each user based on their predicted preferences, the system can enhance the overall user experience and increase user interaction. Additionally, or alternatively, the responsive action may be evaluating different variations or versions of content, ads, or recommendations. By comparing the predicted CTR for different variants, the system can perform A/B testing to determine the most effective design, wording, or presentation format, allowing for continuous optimization and improvement of the system's performance. Additionally, or alternatively, the responsive action may be related to performance tracking. The system may be configured to record the predicted labels obtained from the hybrid FFM model for each instance. These predictions can be used to track and analyze the performance of different content, ads, or recommendations over time. This data may be utilized to provide insights into user preferences, item popularity, and the effectiveness of different strategies, enabling data-driven decision-making for future optimizations.

It may be noted that Steps 130 and/or Step 120 may be repeated using the hybrid FFM model prior to rebuilding or retraining thereof.

On Step 140, the hybrid FFM model may be re-trained. In some exemplary embodiments, the training data used in the hybrid FFM model may consist of multi-field categorical data, where each feature belongs to a specific field. The dataset may be prepared by encoding the categorical features into numerical representations that can be processed by the model. Step 140 may be performed in high frequency, after a short period of time ends, such as every 10 hours, day, every 2 days, or the like.

On Step 150, the hybrid FFM model may be re-built.

In some exemplary embodiments, the re-building may be configured to modify a number of embedding vectors used to represent a field in the hybrid FFM model compared to their respective number in the hybrid FFM model before said re-training.

On Step 152, a determination whether the field is represented by a single embedding vector or by a plurality of field-aware embedding vectors may be performed for each of the set of fields.

In some exemplary embodiments, the determination may be performed based on importance measurements of the field, measuring importance of each embedding of a feature in contributing to the model's performance. The second highest value for each feature's embedding vector is considered to assess its potential benefit from having multiple embeddings. Features whose second highest importance measurement is below a threshold are considered as not benefiting significantly from multiple embeddings. These features are selected to be represented by a single embedding vector, similar to FM model.

It may be noted that in some cases, fields that are represented prior to the re-training with a single embedding vector (such as the first field), may be determined to be represented by a plurality of field-aware embedding vectors in the re-training process. In such cases, the plurality of field-aware embedding vectors may be obtained from a full FFM model upon which the hybrid FFM model was generated.

On Step 154, values for embedding vectors for all fields of the set of fields may be computed. The values may be utilized to determine the labels for instances when applying the hybrid FFM model.

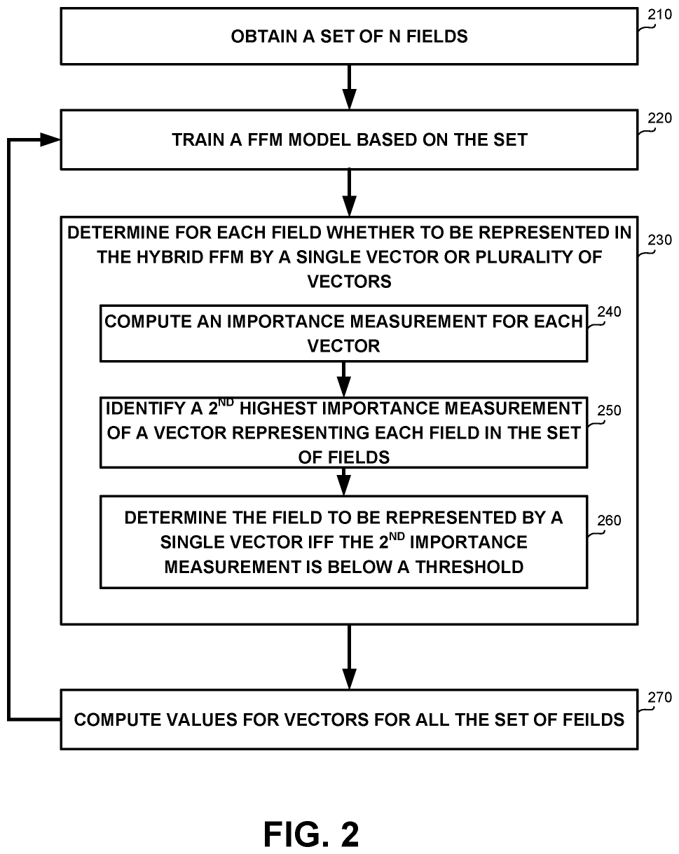

Referring now to FIG. 2 showing a flowchart diagram of a method, in accordance with some exemplary embodiments of the disclosed subject matter.

On Step 210, a set of fields may be obtained. In some exemplary embodiments, the set of fields may consist of N fields, comprising at least a first field and a second field. As an example, in a recommendation system, fields can represent user demographics, item categories, and time of interaction. The training data associated with the set of fields may consist of multi-field categorical data, where each feature belongs to a specific field.

On Step 220, a FFM model may be trained based on the set of fields. The FFM model may be designed to solve various recommendation and regression problems in the field of data science. The of FFM is to capture both the pairwise interactions between features, as well as the interactions between features and their corresponding fields. The FFM model may comprise for each field of the set of fields N−1 embedding vectors representing such field. The FFM model may comprise N²−N embedding vectors. Each embedding vector may correspond to a different field of the set of fields. This allows the model to learn complex relationships and dependencies between features across different fields. It may be noted that the trained FFM model is a full FFM model that can be used to make predictions on new, unseen data by computing the interactions between features and fields, allowing it to provide recommendations or estimate target values based on the learned patterns.

On Step 230, a determination whether the field is to be represented in the hybrid FFM model by a single embedding vector or by a set of N−1 field-aware embedding vector may be performed for each field of the set of fields. The determination may be performed based on the FFM model. As an example, the first field may be determined to be represented by a single embedding vector, while the second field may be determined to be represented by N−1 field aware embedding vectors.

On Step 240, an importance measurement may be computed for each embedding vector of the FFM model.

In some exemplary embodiments, the importance measurement may be computed based on ShAP technique. ShAP may be used for interpretable machine learning, to explain the contributions of each feature to an individual predicted value, e.g., attribute credit to the prediction. ShAP values may be used as an importance measurement for each embedding vector in the FFM model by analyzing the contribution of each feature's embedding to the final prediction. In the context of FFM, each embedding vector represents a feature-field combination. By computing ShAP values for the embedding vectors, we can understand the importance of each feature within its respective field. This helps in determining the significance of interactions between features and fields in the FFM model and provides insights into the model's decision-making process. Accordingly, ShAP values may estimate the importance of each embedding in contributing to the model's performance. Additionally, or alternatively, ShAP values may be utilized to quantify the impact of a feature by estimating the change in the model's output when the feature's value is included or excluded.

On Step 250, a second highest importance measurement (e.g., ShAP value) of an embedding vector representing the field may be identified for each field of the set of fields. In some exemplary embodiments, the second highest importance measurement value for each feature's embedding vector is considered to assess its potential benefit from having multiple embeddings. When multiple embeddings are used, it may imply that the feature has diverse representations or captures distinct aspects within different fields. By identifying the second highest importance measurement, a determination whether the additional embeddings provide valuable information beyond the primary embedding may be performed.

On Step 260, the field may be determined to be represented by a single embedding vector if and only if the second highest importance measurement of the embedding vector representing the field is below a threshold.

In some exemplary embodiments, when the second highest importance measurement is high enough (e.g., above the threshold), it may suggest that the feature's multiple embeddings contribute significantly to the model's predictions and capture different aspects of the feature's relationship with the fields. This may motivate the use of multiple embeddings to enhance the model's capacity to capture complex interactions. If the second highest importance measurement is below the threshold, it may indicate that the additional embeddings for the field do not contribute substantially to the model's predictions.

In some exemplary embodiments, the threshold for determining whether a field should be represented by a single embedding vector can vary depending on the specific problem and dataset. The threshold may be chosen empirically or based on domain knowledge. As an example, the threshold may be a fixed threshold value, such as 0.1 or 0.2. As another example, the threshold may be determined based on a percentage of maximal importance measurement observed across all embedding vectors. For example, if the second highest importance measurement is less than 10% of the maximum importance, a single embedding vector may be sufficient. Additionally, or alternatively, the threshold may be determined based on statistical measures such as mean, standard deviation, or the like. As an example, if the second highest importance measurement is below the mean or falls within a certain range of standard deviation, a single embedding vector can be chosen. Additionally, or alternatively, the threshold may be determined through cross-validation or using a separate validation set. By evaluating the model's performance with different threshold values, one can select the threshold that maximizes a chosen evaluation metric, such as accuracy or F1 score.

It may be noted that the actual threshold value should be determined through experimentation and analysis specific to the problem at hand. The choice of threshold may require domain expertise or fine-tuning based on the desired trade-off between model complexity and performance.

On Step 270, values for embedding vectors of the hybrid FFM model may be computed. The purpose of the hybrid FFM model is to improve performance in recommender systems by effectively capturing and modeling the interactions between features within and between fields. By combining the single embedding vector representation for certain fields with the field-aware embedding vectors for other fields, the hybrid FFM model strikes a balance between the efficiency of traditional FFM and the simplicity of FM.

In some exemplary embodiments, the hybrid FFM model may be generated based on the computed values. The model includes the features determined to have a single embedding vector and the remaining features that will continue to have multiple embedding vectors. The hybrid FFM model strikes a balance between computational efficiency and accurate modeling of feature interactions. It may be noted that the hybrid FFM model will be smaller than the FFM model, and may comprise no more than N²−2N+2 embedding vectors (compared to the N²−N embedding vectors of the FFM model).

In some exemplary embodiments, Steps 230-260 (the re-training process for the hybrid FFM model) may be repeated periodically to adapt to changes in the data and feature importance. By periodically training and updating the hybrid FFM model, the system ensures that it remains effective in capturing feature interactions while reducing training time and computational complexity. Step 220, e.g., training the full FFM model using the training data, may be performed periodically at larger intervals, such as once a month. It may be noted that Step 140 of FIG. 1, e.g., re-training the hybrid FFM model may also be performed periodically, but more frequently, at smaller more intervals, such as once a day, or the like.

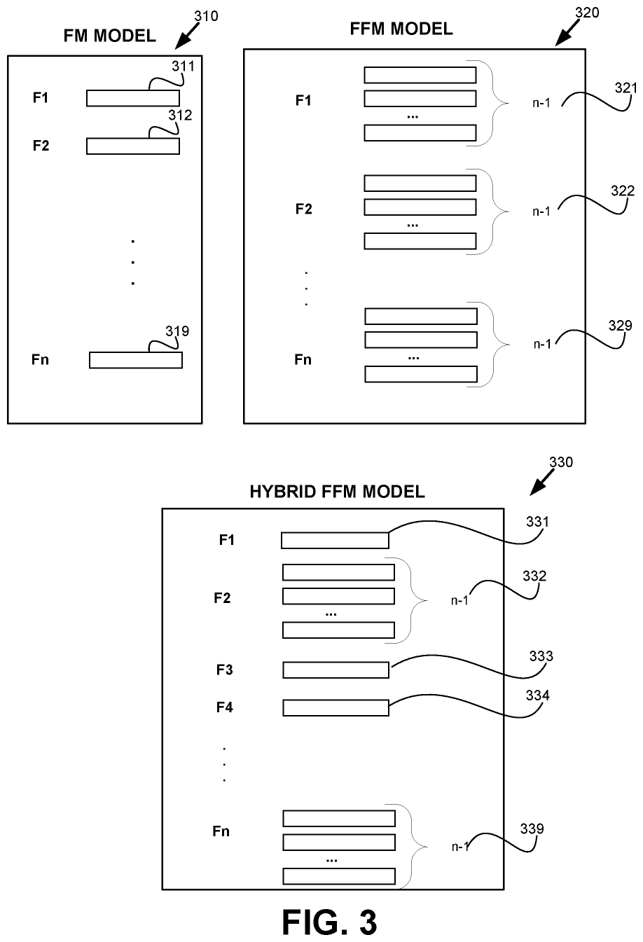

Referring now to FIG. 3 showing a schematic illustration of an exemplary models, in accordance with some exemplary embodiments of the disclosed subject matter.

FM Model 310 may be a machine learning model configured to be used for solving regression and classification problems. FM Model 310 may be designed to capture interactions between features (F₁, F₂ . . . Fₙ) in a dataset, allowing it to learn complex patterns and relationships. FM Model 310 may be based on the idea of factorizing the feature interactions. FM Model 310 may model the relationships between features by decomposing them into lower-dimensional latent factors or embeddings. By considering the interactions between features, the FM model can effectively capture both linear and non-linear dependencies among the features.

In some exemplary embodiments, FM Model 310 may consist of two main components: linear component and factorization component. The linear component may be designed to model the independent effects of each feature. It assigns a weight (or coefficient) to each feature, representing its contribution to the prediction. The linear component may capture the simple, additive relationships between features and their target variable. The factorization component may be designed to capture the interactions between features. It models the pairwise feature interactions by creating low-dimensional embeddings (latent factors) for each feature. These embeddings are combined and summed to calculate the overall interaction effect and may be presented by single embedding vector. As an example, feature F₁ may be represented by Embedding Vector 311, feature F₂ may be represented by Embedding Vector 312, . . . , and feature Fₙ may be represented by Embedding Vector 319. By learning the latent factors, the FM model may be able to capture complex relationships and dependencies between features.

In some exemplary embodiments, the training process of FM Model 310 may involve optimizing the model's parameters, including the feature weights and the latent factors, to minimize a specific loss function. This optimization is typically done using techniques like gradient descent. FM Model 310 may be enabled to handle sparse data efficiently, making it suitable for large-scale datasets with high-dimensional and sparse feature spaces. FM Model 310 can be applied to various tasks, including recommendation systems, CTR prediction, sentiment analysis, or the like.

FFM Model 320 may be an extension machine learning model of FM Model 310, that incorporates the concept of fields or categories. FFM Model 320 may be introduced to handle additional information like field interactions, further enhancing the model's capabilities. FFM Model 320 may be used for solving classification problems, recommendation problems, regression problems, or the like: particularly when considering different feature's fields interactions.

In some exemplary embodiments, FFM Model 320 may be built upon FM Model 310 by considering the interactions between features not only within the feature space but also across different fields. It recognizes that features often have dependencies and interactions that are specific to the field they belong to. As an example, in a recommendation system, features like user demographics, item categories, and time of interaction can be treated as fields. FFM Model 320 extends FM Model 310 by incorporating field information, allowing it to capture both the pairwise interactions within features and the interactions across different fields. It is a powerful tool for solving classification, recommendation and regression problems, offering enhanced modeling capabilities and improved performance.

In the FFM Model 320, each feature is associated with a field, and a separate set of latent factors (embedding vectors) is learned for each feature-field combination. In particular, FFM Model 320 may be based on a set of fields consisting of n fields respective to features (F₁, F₂, . . . Fₙ). FFM Model 320 may comprise for each field of the set of fields n−1 embedding vectors representing such field, each of which corresponds to a different field of the set of fields. In total, FFM Model 320 may comprise n²−n embedding vectors. As an example, feature or field F₁ may be represented by n−1 embedding vectors 321₁₋ₙ, feature or field F₂ may be represented by n−1 embedding vectors 322₁₋ₙ, . . . , and feature or field Fₙ may be represented by n−1 embedding vectors 329₁₋ₙ. Each of n−1 embedding vectors representing a feature may be configured to capture the interactions between a feature and the other features within the same field. By modeling the interactions at the field level, FFM Model 320 can effectively capture complex relationships and dependencies between features across different fields.

FFM Model 320 offers several advantages. It can handle sparse and high-dimensional feature spaces efficiently, making it suitable for large-scale datasets. By explicitly considering the field information, FFM Model 320 can better capture the heterogeneity and interactions within the data. It often leads to improved predictive performance compared to FM Model 310, particularly in scenarios with rich and diverse feature sets

During the training process, FFM Model 320 learns the weights for the feature-field interactions, as well as the feature weights and the latent factors. This optimization may typically be achieved using techniques like stochastic gradient descent or other optimization algorithms. The objective is to minimize a specific loss function, such as logistic loss for binary classification or mean squared error for regression.

In some exemplary embodiments, FFM Model 320 may be trained periodically at intervals of a first time-duration. As the training of FFM models may be complicated and resources consuming, the first time-duration may be selected to be of longer periods, in accordance with the system or the training data, such as once a month, once in few months, or the like.

Hybrid FFM Model 330 may be an adaptation of FFM Model 320 that combines the use of both single embedding vectors (as in FM Model 310) and multiple embedding vectors for representing fields (as in FFM Model 320). Hybrid FFM Model 330 aims to strike a balance between model complexity and performance by selectively choosing the representation for each field.

In Hybrid FFM Model 330, some fields may be represented by a single embedding vector, such as F₁, F₃, and F₄ may be represented by Embedding Vector 331, Embedding Vector 333 and Embedding Vector 334. Other fields, such as such as F₂ and Fₙ may be represented by multiple embedding vectors (n−1 or less) such as by n−1 embedding vectors 332₁₋ₙ, representing field F₂ and n−1 embedding vectors 339₁₋ₙ, representing field Fₙ. Hybrid FFM Model 330 provides a practical approach to leverage the benefits of both single and multiple embedding vectors, allowing for an efficient and effective representation of fields in the model.

In some exemplary embodiments, the decision of how a field is represented in Hybrid FFM Model 330 may typically be based on the importance and contribution of the field's embedding vectors to the overall model performance. Each field in FFM Model 320 may be analyzed to determine whether it should be represented by multiple embedding vectors in Hybrid FFM Model 330 (a field aware feature) or to be represented by a single embedding vector in Hybrid FFM Model 330.

In some exemplary embodiments, the process of determining the representation for each field in Hybrid FFM Model 330 may involve two main steps: measuring importance and selecting representation. Importance measurements may be computed for the embedding vectors of each field. Techniques like ShAP values may be used to assess the importance and contribution of each embedding vector to the model's predictions. These importance measurements provide insights into the relevance of each embedding vector in capturing the interactions and relationships within the field. It may be noted that an importance measurement is computed for each embedding vector of n*(n−1) embedding vectors (321₁₋ₙ-329₁₋ₙ) of FFM Model 320.

In some exemplary embodiments, the representation selection may be performed based on the importance measurements. A threshold value may be defined to determine this selection. If the second highest importance measurement of an embedding vector representing a field is below the threshold, the field is represented by a single embedding vector. If the second highest importance measurement is above the threshold, indicating that the additional embedding vectors provide valuable information, the field is represented by multiple embedding vectors.

In some exemplary embodiments, FFM Model 320 may be utilized to define which feature will have multiple embeddings and which will have a single embedding in Hybrid FFM Model 330. Hybrid FFM Model 330 may provide a practical approach to leverage the benefits of both single and multiple embedding vectors, allowing for an efficient and effective representation of fields in the model. Furthermore, Hybrid FFM Model 330 may enable a more flexible and adaptive representation of fields, focusing computational resources on the most important and informative aspects of the data. By using a combination of single and multiple embedding vectors, Hybrid FFM Model 330 can balance complexity and performance. Hybrid FFM Model 330 retains the benefits of FFM Model 320 in capturing interactions within and across fields while optimizing the resource utilization.

It may be noted that Hybrid FFM Model 330 may be designed to comprise field aware representations and single representations, in predetermined distribution allowing the balance between complexity and performance. As an example, Hybrid FFM Model 330 comprises 3 fields that are represented by a single embedding vector, which are no more than 40% fields. Additionally, or alternatively, a predetermined number or percentage of representation type may be set, such as at least 10% of the fields that are selected to be represented by a single embedding vector; and at least 10% of the fields that are selected to be represented by a plurality of field-aware embedding vectors.

The training and inference processes for Hybrid FFM Model 330 be similar to the standard FFM model, involving optimization of the model's parameters, including the weights for the feature-field interactions and the embedding vectors. The Hybrid FFM model can be trained periodically to adapt to changing data patterns and ensure its effectiveness over time. However, as such training is performed with respect to less embedding vectors, Hybrid FFM Model 330 may be trained once every frequent time period, such as once a day, every few hours, or the like.

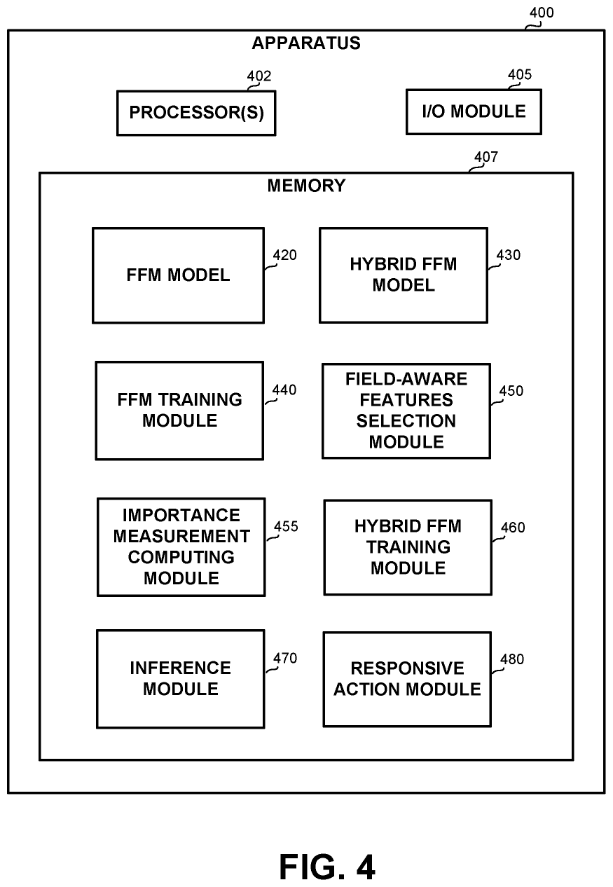

Referring now to FIG. 4 showing a block diagram of an apparatus, in accordance with some exemplary embodiments of the disclosed subject matter.

An Apparatus 400 may be configured to support parallel user interaction with a real-world physical system and a digital representation thereof, in accordance with the disclosed subject matter.

In some exemplary embodiments, Apparatus 400 may comprise one or more Processor(s) 402. Processor 402 may be a Central Processing Unit (CPU), a microprocessor, an electronic circuit, an Integrated Circuit (IC) or the like. Processor 402 may be utilized to perform computations required by Apparatus 400 or any of its subcomponents.

In some exemplary embodiments of the disclosed subject matter, Apparatus 400 may comprise an Input/Output (I/O) module 405. I/O Module 405 may be utilized to provide an output to and receive input from a user, such as, for example outputting labels, instructions for performing responsive actions, obtaining training data, obtaining thresholds, the like.

In some exemplary embodiments, Apparatus 400 may comprise one or more Memory Unit(s) 407. Each Memory Unit 407 may be a hard disk drive, a Flash disk, a Random-Access Memory (RAM), a memory chip, or the like. In some exemplary embodiments, Memory Unit 407 may retain program code operative to cause Processor 402 to perform acts associated with any of the subcomponents of Apparatus 400, such as the training, selection, and inference processes, and enhancing the overall performance and accuracy of the system.

In some exemplary embodiments, Memory Unit 407 may be configured to retain an FFM Model 420, similar to FFM Model 320 presented in FIG. 3. FFM Model 420 may be based on a set of fields consisting of N fields. FFM Model 420 may comprise for each field of the set of fields N−1 embedding vectors representing the field, each of which corresponds to a different field of the set of fields. FFM Model 420 may comprise N²−N embedding vectors. FFM Model 420 may be configured to considers the field information and learns multiple embedding vectors for each feature.

Additionally, or alternatively, Memory Unit 407 may be configured to retain a Hybrid FFM Model 430, similar to Hybrid FFM Model 330 presented in FIG. 3. Hybrid

FFM Model 430 may be based on the set of fields. Hybrid FFM Model 430 may comprise at least one field represented with a single embedding vector and at least a one field represented with N−1 embedding vectors. It may be noted that Hybrid FFM Model 430 is also based on the set of fields of FFM Model 420 and combines single embedding vectors for some fields and N−1 embedding vectors for others. The selection of how each field is represented in the hybrid model is performed by Field-aware Features Selection Module 450.

FFM Training Module 440 may be configured to periodically train FFM Model 420, at specific intervals (referred to as the first time-duration), such as monthly or within a few days, to keep the model updated with the latest data and patterns.

Field-aware Features Selection Module 450 may be configured to select fields to be represented in Hybrid FFM Model 430 with a single embedding vector and/or which field to be represented in Hybrid FFM Model 430 with N−1 embedding vectors. This selection may be based on FFM Model 420 and can be determined by various criteria, such as retaining a predetermined percentage of fields represented by a single embedding vector. As an example, Field-aware Features Selection Module 450 may be configured to keep a predetermined percentage of fields to be represented by a single embedding vector, such as at least 40%, 50%, 60%, 70%, or the like of the N fields.

Additionally, or alternatively, Field-aware Features Selection Module 450 may be configured to perform the selection using importance measurements computed by Importance Measurement Computing Module 455. Importance Measurement Computing Module 455 may be configured to computing an importance measurement for each embedding vector of each field of FFM Model 420. Field-aware Features Selection Module 450 may be configured to check whether a second highest importance measurement of an embedding vector representing the field is below a threshold, in order to determine that the field is to be represented by a single embedding vector. The threshold may be selected based on the predetermined percentage of fields to be represented by a single embedding vector. Additionally, or alternatively, Field-aware Features Selection Module 450 may be configured to determine that field is to be represented by a plurality of embedding vectors in response to the second highest importance measurement being above the threshold. Fields selected by Field-aware Features Selection Module 450 may be represented in hybrid FFM Model 430.

Hybrid FFM Training Module 460 may be configured to periodically train Hybrid FFM Model 430 at shorter intervals (referred to as the second time-duration) than the FFM training.

The second time-duration can be, for example, daily or within a few hours. This frequent training allows the hybrid model to adapt quickly to changing patterns and improve its accuracy. The first time-duration may comprise at least ten consecutive second time-durations. As an example, the first time-duration may be about a month, 20 days, 10 days, or the like.

Inference Module 470 may be configured to utilize Hybrid FFM Model 430 for inference with respect to an instance. Each instance in the inference results inferred by Inference Module 470, may have some features with multiple embeddings and some features with a single embedding (single values with respect to the instance for the single embedding vector, and a plurality of values with respect to the instance corresponding the plurality of embedding vectors).

Responsive Action Module 480 may be configured to perform a responsive action based on the inference result determined by Inference Module 470. The responsive action may be determined by the specific requirements and objectives of the associated system.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “about” as used herein shall denote a range that allows for non-significant variations in the value that do not departure from the essence of the disclosed subject matter. It is explicitly noted that variation of up to plus or minus 10% from the specified value are considered “non-significant”.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method comprising:
obtaining a hybrid Field-aware Factorization Machines (FFM) model, wherein the hybrid FFM model is based on a set of fields, the set of fields comprise at least a first field and a second field, the hybrid FFM model comprises a single embedding vector representing the first field, the hybrid FFM model comprises a plurality of embedding vectors representing the second field, wherein each embedding vector of the plurality of embedding vectors corresponds to a different field of the set of fields in addition to the second field;
performing, by a computerized device, inference using the hybrid FFM model with respect to an instance, whereby obtaining a label, wherein said performing inference comprises extracting based on the instance a first value for the single embedding vector of the first field and a plurality of values corresponding the plurality of embedding vectors representing the second field; and
automatically performing a responsive action based on the label of the instance.

2. The method of claim 1, wherein the set of fields consists of exactly N fields, wherein the plurality of embedding vectors consists of exactly N−1 embedding vectors, each of which corresponding to a different field other than the second field.

3. The method of claim 1 further comprises:
after said automatically performing the responsive action, re-training the hybrid FFM model, wherein said re-training comprises:
determining, for each field of the set of fields, whether the field is represented by a single embedding vector or by a plurality of field-aware embedding vectors: and
computing values for embedding vectors for all fields of the set of fields.

4. The method of claim 3,
wherein said determining for each field of the set of fields whether the field is represented by a single embedding vector or by a plurality of field-aware embedding vectors comprises at least one of:
determining that the first field is to be represented by a plurality of field-aware embedding vectors; and
determining that the second field is to be represented by a single embedding vector:
whereby said re-training modifies a number of embedding vectors used to represent a field in the hybrid FFM model compared to their respective number in the hybrid FFM model before said re-training.

5. The method of claim 1, wherein the hybrid FFM model comprises no more than 40% fields that are represented by a single embedding vector.

6. The method of claim 1, wherein the hybrid FFM model comprises:
at least 10% of the fields that are represented by a single embedding vector; and
at least 10% of the fields that are represented by a plurality of field-aware embedding vectors.

7. A method for training a hybrid FFM model, the method comprises:
obtaining a set of fields, the set of fields comprises at least a first field and a second field, the set of fields consists of N fields;
training a Field-aware Factorization Machines (FFM) model, wherein the FFM model is based on the set of fields, the FFM model comprises for each field of the set of fields N−1 embedding vectors representing the field, each of which corresponds to a different field of the set of fields, whereby the FFM model, comprises N²−N embedding vectors;
based on the FFM model, determining for each field of the set of fields, whether the field is to be represented in the hybrid FFM model by a single embedding vector or by a set of N−1 field-aware embedding vectors, whereby determining that the first field is to be represented by a single embedding vector and determining that the second field is to be represented by N−1 field aware embedding vectors:
computing values for embedding vectors of the hybrid FFM model, whereby the hybrid FFM model comprises no more than N²−2N+2 embedding vectors, whereby the hybrid FFM model is smaller than the FFM model.

8. The method of claim 7, wherein said determining for each field of the set of fields, whether the field is to be represented in the hybrid FFM model by a single embedding vector or by a set of N−1 field-aware embedding vectors comprises:
computing for each embedding vector of the FFM model an importance measurement:
for each field of the set of fields:
identifying a second highest importance measurement of an embedding vector representing the field, and
determining the field to be represented by a single embedding vector if and only if the second highest importance measurement of the embedding vector representing the field is below a threshold.

9. The method of claim 8, wherein the importance measurement of each embedding vector is computed based on Shapely Additive Explanations (ShAP) technique.

10. A computerized apparatus comprising:
one or more memory units and one or more processors;
said one or more memory units being adapted to retain:
a Field-aware Factorization Machines (FFM) model, wherein the FFM model is based on a set of fields consisting of N fields, the FFM model comprises for each field of the set of fields N−1 embedding vectors representing the field, each of which corresponds to a different field of the set of fields, whereby the FFM model, comprises N²−N embedding vectors;
a hybrid FFM model, wherein the hybrid FFM is based on the set of fields, wherein at least a first field of the set of fields is represented in the hybrid FFM model with a single embedding vector and at least a second field of the set of fields is represented in the hybrid FFM model with N−1 embedding vectors, wherein each embedding vector of the N−1 embedding vectors corresponds to a different field of the set of fields in addition to the second field; and
at least one of said one or more processors being adapted to periodically train the FFM model, wherein the FFM model is based on the set of fields, wherein said periodically training the FFM model is performed at intervals of a first time-duration;
at least one of said one or more processors being adapted to select the first field to be represented in the hybrid FFM model with a single embedding vector and to select the second field to be represented in the hybrid FFM model with N−1 embedding vectors, wherein the selection of the first and second fields is based on the FFM model;
at least one of said one or more processors being adapted to periodically train the hybrid FFM model, wherein said periodically training the hybrid FFM model is performed at intervals of a second time-duration, the second time-duration is smaller than the first time-duration;
at least one of said one or more processors being adapted to utilize the hybrid FFM model for inference with respect to an instance, whereby obtaining an inference result, wherein the inference result is based on a first value with respect to the instance for the single embedding vector of the first field and based on a plurality of values with respect to the instance corresponding the plurality of embedding vectors representing the second field; and
at least one of said one or more processors being adapted to perform a responsive action based on the inference result.

11. The computerized apparatus of claim 10, wherein the first time-duration includes at least ten consecutive second time-durations.

12. The computerized apparatus of claim 10, wherein the hybrid FFM model comprises no more than N²−2N+2 embedding vectors, whereby the hybrid FFM model is smaller than the FFM model.

13. The computerized apparatus of claim 10, wherein at least 50% of the N fields are selected to be represented by a single embedding vector.

14. The computerized apparatus of claim 13, wherein at least 60% of the N fields are selected to be represented by a single embedding vector.

15. The computerized apparatus of claim 11, wherein the selection with respect to a field is performed by:
computing an importance measurement for each embedding vector of the FFM model that is associated with the field;
identifying a second highest importance measurement of an embedding vector representing the field;
in response to the second highest importance measurement being below a threshold, determining that the field is to be represented by a single embedding vector; and
in response to the second highest importance measurement being above the threshold, determining that the field is to be represented by a plurality of embedding vectors.

16. The computerized apparatus of claim 15, wherein the single embedding vector is the embedding vector representing the field in the FFM model with a highest importance measurement.

17. The computerized apparatus of claim 10, wherein the first time-duration is about a month, wherein the second time-duration is about a day.

18. A system for hybrid Field-aware Factorization Machines (FFM) model generation and update, comprising:
an FFM model, wherein the FFM model is based on a set of fields consisting of N fields, the FFM model comprises for each field of the set of fields N−1 embedding vectors representing such field, each of which corresponds to a different field of the set of fields, whereby the FFM model, comprises N²−N embedding vectors;
a training module configured to train the FFM model periodically at intervals of a first time-duration;
an identification module configured to identify, based on the FFM model, field aware features to be represented by multiple embedding vectors in the hybrid FFM and features to be represented by a single embedding vector in the hybrid FFM;
a generation module configured to generate the hybrid FFM model based on the set of fields, wherein the hybrid FFM model comprises the determined representation for each field, wherein at least one field in the hybrid FFM is represented by a single embedding vector and at least one field in the hybrid FFM is represented by the N−1 embedding vectors representing the field in the FFM model;
an update module configured to periodically train the hybrid FFM model once every frequent time period.

19. The system of claim 18, further comprises:
an importance computation module configured to compute an importance measurement for each embedding vector of the FFM model;
wherein said identification module is configured to determine, for each field of the set of fields, whether the field is to be represented in the hybrid FFM model by a single embedding vector or by a set of N−1 field-aware embedding vectors, wherein the determination is based on the second highest importance measurement of the embedding vector representing each field being below a threshold.
